(19) United States
(12) Patent Application Publication
(10) Pub. No.: US 2009/0305715 A1
(43) Pub. Date: Dec. 10, 2009

(54) CHANNEL QUALITY REPORTING IN A WIRELESS COMMUNICATION SYSTEM

(75) Inventors: Satyen D. Barve, Palatine, IL (US); Fei Tong, Swindon (GB); Nick W. Whinnett, Marlborough (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/144,264

(22) Filed: Jun. 23, 2008

Related U.S. Application Data
(60) Provisional application No. 61/058,632, filed on Jun. 4, 2008.

(51) Int. Cl. H04Q 7/20

(52) U.S. Cl. 455/452.2

(57) ABSTRACT

A wireless communication system comprises a scheduler for scheduling air interface data for a plurality of user equipments. A control channel scheduler estimates a scheduling time for a scheduling of air interface data to a first user equipment of the plurality of user equipments in response to a current scheduling metric for the first user equipment and a reporting processor generates a channel quality reporting request for the user equipment in response to the scheduling time. The channel quality reporting request is transmitted to the user equipment which proceeds to provide channel quality reports in accordance with the request. The approach may improve performance in a wireless communication system by reducing channel reporting resource requirements while still providing channel quality information when needed. The invention may be particularly suitable for a Long Term Evolution 3^{rd} Generation Partnership Project cellular communication system or an IEEE 802.16 wireless communication system.

### REFERENCE(S) TO RELATED APPLICATION(S)

The present application claims priority from a provisional application, Ser. No. 61058632, entitled “CHANNEL QUALITY REPORTING IN A WIRELESS COMMUNICATION SYSTEM,” filed Jun. 4, 2008, which is commonly owned and incorporated herein by reference in its entirety.

### FIELD OF THE INVENTION

The invention relates to channel quality reporting in a wireless communication system and in particular, but not exclusively, to channel quality reporting in cellular communication systems.

### BACKGROUND OF THE INVENTION

Cellular communication systems supporting mobile communications have become ubiquitous and in particular second generation cellular communication systems, such as the Global System for Mobile Communication (GSM), and third Generation cellular communication systems, such as the Universal Mobile Telecommunication System (UMTS), have become widespread. Other wireless communication systems include Wireless Local Area Networks (WLANs), such as IEEE 802.11x systems, or Wireless Metropolitan Area Networks (WMANs), such as IEEE 802.16 networks which are also known as WiMAX™ (Worldwide Interoperability for Microwave Access)

In order to provide improved communication services and increased efficiency, wireless communication systems are continuously developed and enhanced. For example, currently, the 3rd Generation Partnership Project (3GPP) standards body is in the process of standardising improvements to GSM and UMTS known as Long Term Evolution (LTE).

Many advanced wireless communication systems, such as LTE and WiMAX™, use very fast scheduling of communication resources that are allocated to user traffic and control data over the air interface. Specifically, scheduling of user traffic may be performed in the individual serving base station (also referred to as a node B or access point) thereby allowing scheduling to be so fast that it can follow changes in the characteristics of the propagation channels to the individual user equipments. This is used to schedule data for user equipments such that data is predominantly scheduled for user equipments which currently experience advantageous propagation conditions.

In LTE, the fast scheduling may be performed both for uplink user data traffic transmitted on a physical channel known as the Physical Uplink Shared CHannel (PUSCH) and for downlink user data traffic transmitted on a physical channel known as the Physical Downlink Shared CHannel (PDSCH). The resource allocation can be changed in subframes having a duration of only 1 msec with a typical scheduling interval (i.e. how often the scheduling algorithm runs) of between 1 and 10 subframes. One frame consists of 10 such consecutive subframes. The PUSCH and PDSCH are shared channels wherein the scheduling is not only dependent on the current propagation conditions but also on the resource requirement of the user equipments. In order to simplify the scheduling and to reduce the signaling overhead, LTE allows for persistent scheduling wherein a resource allocation for the PUSCH or PDSCH may be made for a plurality of frames and scheduling intervals.

In order to provide efficient fast scheduling in the base station, the user equipment must transmit uplink control information to the scheduling base station. Specifically, the UE transmits Channel Quality Indicator (CQI) data which is indicative of the current propagation conditions for the user equipment. Based on measurements of the received signal the user equipment generates a CQI which may indicate a modulation scheme and data rate that is considered to be supportable by the air interface communication channel from the base station to the user equipment, or which may be a measure of the Signal to Noise plus Interference Ratio. As another example, LTE uses a retransmission scheme (referred to as ARQ or Hybrid ARQ (HARQ)) and the UE transmits ARQ data in the form of uplink acknowledge (ACK) or non-acknowledge (NACK) messages which are used to determine whether individual data packets need to be retransmitted.

Another technique that has been adopted in LTE is the use of multiple antenna elements at the base station and possibly at the user equipment. Specifically, LTE allows for the use of transmission techniques that involve transmitting a data stream by simultaneously transmitting different signals derived from the data stream from different antennas. The receiver(s) may also comprise a plurality of antennas each of which receive a combined signal corresponding to the transmitted signals modified by the individual propagation characteristics of the radio link between the individual antennas. The receiver may then retrieve the transmitted data stream by evaluating the received combined signal.

Such techniques are known as Multiple Transmit Multiple Receive (MTMR) or Multiple Input Multiple Output (MIMO) schemes and can be designed to derive benefit from spatial diversity between the antennas in order to improve detection. Indeed, the equivalent Signal to Noise Ratio (SNR) of the combined signal is typically increased compared to the single antenna case thereby allowing higher channel symbol rates or higher order modulation constellations. This may increase the data rate for the communication link and thus the capacity of the communication system.

LTE allows for the base station to pre-encode the transmitted MIMO signals by setting weights for the individual antenna elements such that the signals are received in phase at the user equipment. However, in order to do so, the weights must be adjusted depending on the specific propagation channels experienced between each transmit-receive antenna element pair. In LTE, this is achieved by the user equipment estimating a channel response and in response determining suitable weights that should be applied at the base station. This information is reported to the base station using a Precoding Matrix Index (PMI) report. The PMI is thus used to signal the antenna weights recommended by the user equipment for the individual antenna elements.

The uplink control information (and in particular CQIs and PMIs) is transmitted using physical uplink channels. Specifically, in subframes wherein the user equipment transmits uplink user data traffic on the PUSCH, the control data can in LTE be embedded within the transmission such that the control information is transmitted to the base station using the PUSCH. However, for subframes wherein no uplink user data traffic is transmitted on the PUSCH, the user equipment uses a physical uplink channel known as the Physical Uplink Control CHannel (PUCCH) to transmit the control information.

Thus, in many LTE scenarios the CQI and PMI reports must be transmitted on the PUCCH and indeed in high load situations (and in particular in asymmetric situations with relatively higher downlink than uplink loading), a large number of user equipments may need to use the PUCCH resource for control information reporting. However, the resource of the PUCCH tends to be limited and may in some cases limit the capacity of the system as a whole and therefore it is important to reduce the PUCCH resource usage.

Similarly, in IEEE 802.16 systems, channel quality information in the form of CQI data is transmitted from the user equipments (remote terminals) to the base station (access point) using suitable air interface resources. Specifically, each user equipment may be allocated a control channel known as a CQICH (Channel Quality Indicator CHannel) from an uplink resource block known as a Fast FeedBack (FFB) region. The CQICH is then used to repeatedly transmit CQIs at regular intervals (typically 1 to 8 frames apart). The CQIs are then used to schedule data for the individual user equipments.

However, as for LTE, the resource available for CQICHs is relatively limited and in congested areas wherein many user equipments are receiving downlink data, the resource of the FFB region may often be limiting.

In order to schedule air interface data efficiently it is advantageous for the scheduling to take into account the current propagation conditions as indicated by the CQIs and this is exploited in both LTE and IEEE 802.16 systems. However, it is accordingly advantageous for the channel quality information to be available to the scheduler prior to the scheduling of air interface data for the user equipment. Accordingly, an approach used for channel reporting is that a reporting channel is allocated to a user equipment whenever downlink data is received by the scheduler for the user equipment. The user equipment then proceeds to transmit channel quality information which is used to decide when the downlink data should be scheduled. However, in particular for very bursty scenarios where a lot of user equipments receive downlink data in relative short data bursts (such as is e.g. typical for Internet browsing applications), the required control channel resource (e.g. FFB and PUSCH resource) tends to be excessive as very often unnecessary channel quality reporting occurs. Furthermore, the signaling overhead resulting from a frequent allocation and reallocation of the limited control channel resource tends to be substantial.

Hence, an improved system would be advantageous and in particular a system allowing increased flexibility, reduced signaling overhead, improved channel quality reporting, reduced resource usage, facilitated operation and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a wireless communication system comprising: a scheduler for scheduling air interface data for a plurality of user equipments; an estimator for estimating a scheduling time for a scheduling of air interface data to a first user equipment of the plurality of user equipments in response to a current scheduling metric for the first user equipment; a generating unit for generating a channel quality reporting request for the user equipment in response to the scheduling time; and a transmitter for transmitting the channel quality reporting request to the first user equipment.

The invention may allow improved performance of a wireless communication system. In particular, it may allow a reduced signaling overhead, reduced resource usage and/or improved channel quality reporting resulting in improved performance of the communication system as a whole.

In particular, the invention may in many embodiments reduce the resource required for channel quality reporting thereby improving the capacity of the cellular communication system. In particular, channel quality reporting may be reduced to times at which it is particularly important, and unnecessary channel quality reporting may in many scenarios be avoided or reduced.

The approach may allow channel quality reporting to be available prior to scheduling while still maintaining low channel quality reporting resource usage. The scheduler may use current channel quality information when scheduling data for the first user equipment thereby allowing a more efficient resource utilization.

The use of a current scheduling metric for the first user equipment in controlling when the first user equipment provides channel quality reporting may provide a particularly efficient trade-off between resource usage for the reporting and the resource usage of user data of the total air interface resource. For example, it may allow channel quality data to be communicated only when it is important for effective scheduling and/or for setting of transmission parameters for user data air interface communications. In particular, it may allow the channel quality reporting to be adapted to the current scheduling and traffic conditions experienced in the system.

The scheduling metric may specifically be a dynamic scheduling metric reflecting a current prioritization of data for the first user equipment relative to a current scheduling priority of data for other user equipments.

The invention may in particular provide improved performance in situations with high loading and bursty traffic profiles.

The first user equipment comprises functionality for receiving the channel quality reporting request and for generating and directly or indirectly transmitting channel quality data to the scheduler. The channel quality data may for example include CQIs or PMIs.

The channel quality reporting request may comprise an indication of an allocated uplink control channel resource for the channel quality reporting.

The air interface data may be downlink air interface data or may be uplink air interface data.

In accordance with another aspect of the invention there is provided a base station for a wireless communication system, the base station comprising: a scheduler for scheduling air interface data for a plurality of user equipments; an estimator for estimating a scheduling time for a scheduling of air interface data to a first user equipment of the plurality of user equipments in response to a current scheduling metric for the first user equipment; a generating unit for generating a channel quality reporting request for the user equipment in response to the scheduling time; and a transmitter for transmitting the channel quality reporting request to the first user equipment.

In accordance with another aspect of the invention there is provided a method of operation for a wireless communication system comprising a scheduler for scheduling air interface data for a plurality of user equipments, the method comprising: estimating a scheduling time for a scheduling of air interface data to a first user equipment of the plurality of user equipments in response to a current scheduling metric for the first user equipment; generating a channel quality reporting request for the user equipment in response to the scheduling time; and transmitting the channel quality reporting request to the first user equipment.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a wireless communication system in accordance with some embodiments of the invention;

FIG. 2 is an illustration of an example of a base station in accordance with some embodiments of the invention; and

FIG. 3 is an illustration of an example of a method of operation for a wireless communication system in accordance with some embodiments of the invention.

### DETAILED DESCRIPTION OF SOME EMBODIMENTS OF THE INVENTION

The following description focuses on examples of an IEEE 802.16 (WiMAX™) communication system and a 3^{rd} Generation Partnership, 3GPP, cellular communication system (and in particular a Long Term Evolution (LTE) communication system). However, it will be appreciated that the invention is not limited to this application but may be applied to many other wireless communication systems. The description furthermore focuses on the application of approach to downlink data scheduling but it will be appreciated that in some embodiments, the approach may be applied to uplink data scheduling.

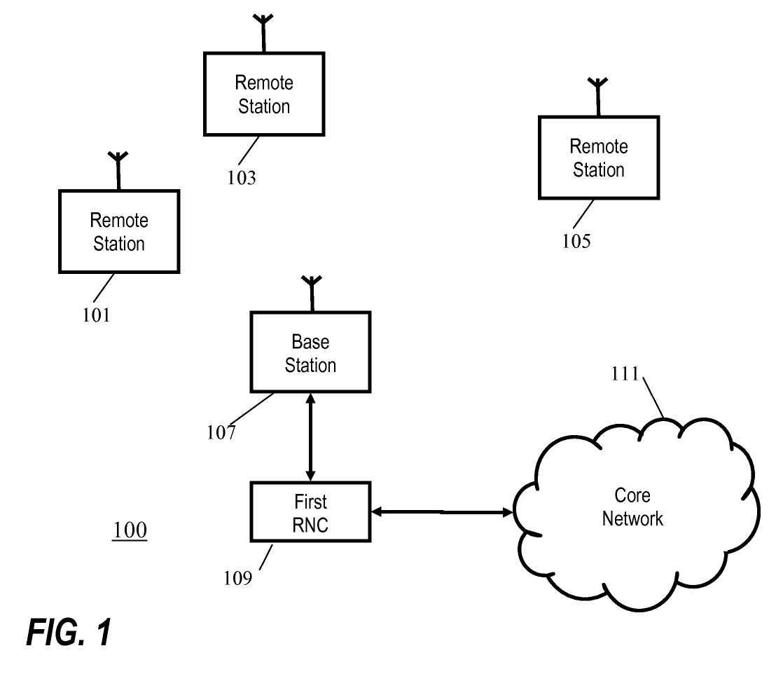

FIG. 1 illustrates an example of a wireless communication system in accordance with some embodiments of the invention. In the specific example, the cellular communication system is an LTE or IEEE 802.16 (WiMAX™) communication system which supports a plurality of user equipments. In the example, three user equipments 101, 103, 105 supported by a base station 107 (also known as a node B or Access Point) are shown but it will be appreciated that a typical base station of a wireless communication system will typically support a large number of user equipments. A user equipment may be any communication entity capable of communicating with a base station (node B/access point) over the air interface including e.g. a mobile phone, a mobile terminal, a mobile communication unit, a remote station, a subscriber unit, a 3G User Equipment etc.

For the LTE example, the communication between the user equipments 101-105 and the base station 107 are in accordance with the LTE specifications and specifically the communications make use of the LTE control and data channels including the PDSCH and PUSCH for user data communications and the PUCCH and PDCCH (Physical Downlink Control CHannel) for control signaling.

For the IEEE 802.16 example, the communication between the user equipments 101-105 and the base station 107 are in accordance with the IEEE 802.16 specifications and specifically the communications make use of the IEEE 802.16 control and data channels including the downlink and uplink subframe for user data communications and the FFB region for control signaling.

In the LTE example, the base station 107 is coupled to a Radio Network Controller (RNC) 109 which is further coupled to a core network 111. As will be known to the skilled person, an RNC performs many of the control functions related to the air interface including some radio resource management and routing of data to and from appropriate base stations. A core network interconnects RNCs and is operable to route data between any two RNCs, thereby enabling a user equipment in a cell to communicate with a user equipment in any other cell. In addition, a core network comprises gateway functions for interconnecting to external networks such as the Public Switched Telephone Network (PSTN), thereby allowing user equipments to communicate with landline telephones and other communication terminals connected by a landline. Furthermore, the core network comprises much of the functionality required for managing a conventional communication network including functionality for routing data, admission control, resource allocation, subscriber billing, user equipment authentication etc.

In the IEEE 802.16 example, the base station 107 may be directly coupled to the core network 111 which as will be known by the skilled person performs many of the same functions as for the LTE example including data routing, admission control, resource allocation, subscriber billing, user equipment authentication etc.

In a typical high load scenario, a large number of user equipments 101-105 may at the same time receive downlink data transmissions from the base station 107. In the example, the downlink data communication is very bursty with the user equipments 101-105 receiving downlink user data in relatively short bursts (for example a large number of user equipments may be supporting Internet browsing applications). The downlink transmissions may for example be transmitted using the shared downlink channel PDSCH for the LTE example and the downlink subframe for the IEEE 802.16 example.

In order to provide an efficient scheduling and to set transmission characteristics optimally for each downlink connection, the base station 107 uses information about the propagation channel between the base station and the user equipment. In LTE this is achieved by the individual user equipments sending measurement reports which include CQIs that specify the use of a specific set of transmission parameters estimated to be suitable for the current propagation characteristics for the user equipment. Furthermore, for user equipments and base stations that support MIMO operation, the user equipment may report a PMI which provides an index allowing the base station to select a suitable set of weights for each transmit antenna element. In IEEE 802.16 systems, different antenna weights are determined from feedback received on a separate channel called the sounding channel. In the absence of this channel the signal itself (i.e. not the value) received in the FFB region is used.

In LTE, the reporting of the CQI and PMI is performed using the PUCCH and accordingly a PUCCH resource is allocated to each user equipment involved in a downlink communication. In IEEE 802.16, the CQI is reported on a CQICH allocated using resource of the FFB region.

In the system of FIG. 1, the control channel reporting resource and the reporting operation is controlled such that channel reporting is targeted to only occur in a time interval in which it is particularly needed. Furthermore, this time interval is selected such that it is in advance of the transmissions to the user equipment thereby allowing the scheduling and the transmission characteristics used for the transmission to reflect the current propagation channel characteristics. Furthermore, the control channel resource reporting is limited to the time interval thereby reducing the control channel resource used by the individual user equipment and thus allowing support for an increasing number of user equipments and increasing the capacity of the system as a whole.

Specifically, the base station 107 is arranged to estimate exactly when downlink data for a specific user equipment 101 is going to be scheduled. It then determines a reporting start time which is before the estimated scheduling time but by less than a predetermined value. The predetermined value is relatively short, e.g. 10-20 frames (or subframes for an LTE system), thereby ensuring that the channel quality reporting is not started until shortly before the data is expected to be required by the base station for scheduling and downlink transmission parameter setting.

The scheduling time is estimated on the basis of a current scheduling metric which may reflect a current prioritization of the user equipment 101 relative to a current prioritization of other user equipments having pending downlink data waiting to be scheduled. Thus, the scheduling metric may be a metric which is indicative of the current ranking of the user equipment 101 relative to other user equipments 103-105 waiting to be scheduled and may specifically reflect the amount of data for other user equipments 103-105 that is likely to be scheduled before the downlink data for the user equipment 101 is scheduled.

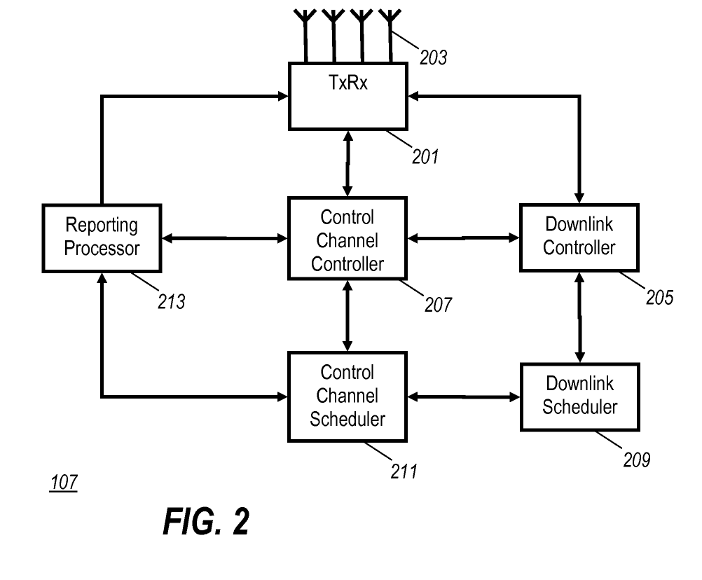

FIG. 2 illustrates an example of elements of the base station 107. The base station 107 comprises a transceiver 201 which is arranged to transmit and receive air interface signals from the user equipments 101-105. In the example, the transceiver 201 is a MIMO capable transceiver comprising an antenna array 203 with a plurality of antenna elements.

The transceiver 201 is coupled to a downlink controller 205 which is arranged to control all aspects of downlink user data communications. Thus, in the LTE example, the downlink controller 205 is responsible for communicating user data in the PDSCH including encoding and structuring the user data appropriately for the PDSCH, controlling the MIMO weights for the antenna elements, controlling retransmissions etc. In the IEEE 802.16 example, the downlink controller 205 is responsible for the same operations for communications of the downlink subframe channel.

The transceiver 201 is furthermore coupled to a control channel controller 207 which is arranged to control all aspects of uplink control channels and specifically is responsible for performing the operations required to establish and support control channels for channel quality reporting from the user equipments 101-105.

Thus, in the LTE example, the control channel controller 207 supports the PUCCH and is responsible for the communications with the user equipments 101-105 on the PUCCH including decoding and structuring of the control data received on the PUCCH and specifically for receiving the CQIs and PMIs received from the individual user equipments 103-105. In the IEEE 802.16 example, the control channel controller 207 is responsible for setting up and supporting the CQICH channels for receiving the CQIs and PMIs from the user equipments 101-105.

The base station 107 furthermore comprises a downlink scheduler 209 which is arranged to schedule air interface resource for user data communications to the user equipments 101-103. Specifically, in the LTE example, the downlink scheduler 209 is operable to allocate resource of the PDSCH to the individual user equipments 101-105. Thus, the base station 107 may receive downlink user data from the RNC 109 to be transmitted to the user equipments 101-105 over the PDSCH. This data is buffered by the downlink scheduler and then allocated to the PDSCH in response to a suitable scheduling algorithm. In the IEEE 802.16 example, the downlink scheduler 209 is responsible for the same actions with respect to the downlink subframe channel.

The scheduling made by the downlink scheduler 209 takes into account the channel quality of the propagation channels between the base station 107 and the individual user equipments 101-105. Specifically, the downlink scheduler 209 uses the CQIs to assess when the propagation channels to individual user equipments 101-105 are particularly good and it seeks to schedule data on the downlink data channel to user equipments 101-105 which currently experience advantageous propagation conditions.

Similarly, when downlink user data is scheduled for a specific user equipment 101, the downlink controller 205 uses the CQI and PMI information to select the appropriate transmission scheme (modulation format, error protection etc) and the appropriate antenna element weights for the optimal MIMO operation.

The base station 107 furthermore comprises a control channel scheduler 211 which is arranged to allocate resource of the channel quality reporting channel (PUCCH or FFB region) to individual user equipments 101-105. Thus, the control channel scheduler 211 allocates a PUCCH channel in specific time slots/frames (for LTE) or CQICHs (for IEEE 802.16) to user equipments 101-105 such that they can report CQIs and PMIs.

In the system of FIG. 1, the control channel resource may be allocated to specific user equipments 101-105 in a scheduling grant which provides a control channel resource in a specific defined time interval. Specifically, the control channel scheduler 211 can allocate a periodically repeating PUCCH or FFB resource to a user equipment 101 (e.g. a time slot in every N^{th} subframe may be allocated). However, the allocation of control channel resource is in the example limited to a specific time interval e.g. represented as a fixed number of subframes. Thus, in response to receiving the scheduling grant, the user equipment 101 proceeds to transmit CQI and PMI information for the duration of the time interval. However, at the end of the time interval the user equipment 101 terminates the transmission of the CQI and PMI information. Thus, a simple signaling of a scheduling grant allows the efficient control of the control channel resource and CQI and PMI reporting of the user equipment 101. Furthermore, the control channel scheduler 211 can readily reallocate (e.g. in advance) the control channel resource to another user equipment 103, 105 from the end of the time interval.

The control channel scheduler 211 is coupled to the downlink scheduler 209 and receives scheduling metrics for the user equipments 101-105 for which data is pending scheduling by the downlink scheduler 209. In response, the control channel scheduler 211 proceeds to estimate a scheduling time for the scheduling of the air interface resource of the downlink data channel to the first user equipment 101, i.e. it proceeds to estimate a scheduling time for scheduling of downlink user data to the first user equipment 101.

It will be appreciated that in some scenarios the scheduling time may correspond to the time the scheduling is actually being performed and thus when the decision is made to transmit data to the user equipment. This may be relevant for channel quality reporting used in the scheduling process. In other scenarios the scheduling time may correspond to the time the downlink data is actually scheduled for transmission on the downlink user data channel, i.e. to the time of the data actually being transmitted. This may be relevant for channel quality reporting used to set transmission parameters). However, in most embodiments the scheduling is very fast and the difference between these times is insignificant and the times may be considered equivalent.

The control channel scheduler 211 then proceeds to determine a reporting start time preference for channel quality reporting in response to the scheduling time. The reporting start time is typically selected such that it will provide a sufficiently high probability that suitable CQI/PMIs have been received in time for these to be taken into account when performing the downlink scheduling and setting the transmission parameters for the first user equipment 101. Specifically, the approach may typically reduce the delay between the time when the channel is measured and reported and the time when the channel quality information is used by the base station 107.

The reporting start time may for example be determined by subtracting a predetermined value from the estimated scheduling time. For example, the reporting start time may be set as ten (sub)frames prior to the frame of the estimated scheduling time.

The control channel scheduler 211 is coupled to a reporting processor 213 which is arranged to generate a channel quality reporting request in response to the estimated scheduling time, and which specifically may generate a channel quality reporting request that requests the user equipment 101 to begin CQI and/or PMI reporting from the determined reporting start time preference.

In the specific example, the reporting request is implemented as a Scheduling Grant (SG) which is a data block allocating the necessary control channel resource to the user equipment 101. Thus, the reporting request is in the form of an SG which comprises a resource indication for the control channel resource. Specifically, the reporting processor 213 generates an SG which allocates the scheduled CQICH or PUCCH resource to the user equipment 101. For example, the SG may allocate a fixed number of (sub)frames to the user equipment 101 for channel quality reporting. The allocated resource is specifically allocated from the reporting start time. In response to receiving this scheduling grant/reporting request, the user equipment 101 proceeds to transmit CQI and/or PMI in the allocated resource.

The control channel scheduler 211 and reporting processor 213 are furthermore coupled to the control channel controller 207 which is provided with the required information in order for the control channel controller 207 to proceed to correctly receive, process and forward the CQI and PMI data from the user equipment 101.

Thus, in the example, the SG is indicative of the reporting start time preference and the begin time of the resource allocation corresponds to the reporting start time at which the user equipment 101 should start transmitting CQI and/or PMI reports. It will be appreciated that in some embodiments, the SG/reporting request may contain data specifically identifying a time at which channel quality reporting should be initiated whereas in other embodiments the reporting start time may be implicit in the transmission of the reporting request itself.

In the example, the allocated control channel resource is a time limited resource. For example, the resource allocation and reporting requirement may be limited to a possibly short time interval corresponding to the time of the scheduling, i.e. the reporting of CQI and PMI may be limited to the time at which it is required.

The described approach may allow an improved performance of the communication system. Specifically, some data for a user equipment may be pending scheduling but is unlikely to be scheduled for some time. For example, if new data is received for a low priority user equipment at a time of relatively high loading, it is likely to incur some delay before being scheduled. Similarly, data for a user equipment for which a part of a large amount of pending data has recently been scheduled is likely to not be scheduled for a while. Depending on the scheduling priority of the user equipment and other user equipments, the control channel scheduler 21 1 may estimate how long (e.g. in terms of a frame duration N) it be before the user equipment is considered for scheduling. The duration N may be estimated as a function of the amount of data pending for higher priority user equipments, the respective channel conditions for the other user equipments etc. Once N is determined, a PUSCH or FFB slot is allocated to the user equipment a few frames before the frame in which the scheduling is expected to occur. Furthermore instead of allocating a long duration for reporting CQI and/or PMI, the control channel resource may only be allocated for a short duration such as e.g. 20 frames or less. In the example, the resource allocation and thus the reporting request duration is time limited and the control channel resource is automatically freed at the end of the time interval. This may allow an efficient resource allocation while ensuring a low signaling overhead as no other signaling is required in order to free up the control channel resource for another user equipment.

The approach may provide a more resource efficient channel quality reporting operation. For example, in a scenario wherein a greedy scheduler algorithm is used (i.e. a scheduling algorithm that schedules the entire pending data amount for a user equipment when the user equipment reaches the highest priority), the CQI information is only needed in bursts when the data needs to be sent (but is not needed when the data is pending and the user equipment is not yet up for scheduling). In contrast to a conventional approach wherein the base station starts requesting CQI information as soon as it detects that data is pending for the user equipment, this substantially reduces the resource required for the channel quality reporting.

It will be appreciated that in different embodiments, different algorithms may be used for estimating the scheduling time and the reporting start time.

For example, in some embodiments, the channel quality reporting request is transmitted in response to a detection that a scheduling priority of the first user equipment meets a first criterion.

For example, the scheduling time estimate may simply be determined as being within a given time interval from the current time when the priority of the first user equipment 101 increases above a threshold. The priority may be a relative priority relative to other user equipments. As a specific example, when the first user equipment 101 enters a set of user equipment corresponding to the highest K prioritised user equipments (in other words it is amongst the K next user equipments to be scheduled), it is estimated that the scheduling time will be within a given duration from the current time. In response, the reporting processor 213 may proceed to generate and transmit the SG/reporting request.

As another example, the control channel scheduler 211 may specifically calculate an estimate scheduling frame for the user equipment 101 in response to the data that is currently pending scheduling for both the first user equipment 101 and for other user equipments 101 and in response to the relative priority of the user equipments. E.g. the control channel scheduler 211 can sum the data pending for all user equipments currently prioritised ahead of the first user equipment 101. The amount of channel resource required for communicating this total data amount can then be calculated. Based on the air interface resource available to the scheduler per time interval (e.g. frame), the control channel scheduler 211 can then calculate the time at which this data is likely to have been scheduled and thus when the first user equipment 101 is likely to be scheduled. This time can then be used as the estimation scheduling time.

It will be appreciated that in some cases, the propagation channel quality may be taken into account when calculating the estimated scheduling time. Specifically, CQIs received from other user equipments 103-105 may be used to determine how much air interface resource is required for communicating the data amount pending for the higher prioritised user equipments 103-105. E.g. for a high quality propagation channel, more data can be communicated in a given resource block (e.g. time slot/frame) and thus fewer resource blocks are needed. If channel conditions of higher priority user equipments are not known, an estimate or default value thereof can be used.

In some embodiments, the SG/reporting request may further comprise one or more reporting attributes for reporting from the first user equipment 101.

For example, the SG/reporting request can include data specifying what should be reported (e.g. CQIs or PMIs), how often and with what parameters. E.g. the scheduling grant can include data specifying an interval between reports thereby allowing the base station to dynamically control the trade off between measurement update intervals for the channel quality measurements and the control channel resource usage.

As another example, the scheduling grant may comprise an indication of a channel quality reporting frequency bandwidth granularity. For example, in LTE, PMI reporting may be selected to relate to different frequency bandwidths of different sizes. Thus, the scheduling grant may specify whether a single PMI report should be reported for the entire frequency bandwidth or whether individual PMIs should be reported for two or more smaller frequency bands.

In some embodiments, the SG/reporting request can comprises an indication of a stop condition for the first user equipment to terminate channel quality reporting. In particular, in the particular example, the resource allocation and reporting requirement is time limited such that the reporting should stop when the allocated time intervals ends.

In other embodiments, the SG/reporting request may comprise an indication of an event that should result in the first user equipment 101 terminating the reporting. For example, the SG/reporting request may indicate that the CQI reporting should terminate when the downlink data is actually scheduled for the first user equipment 101. This may e.g. be detected in response to the first user equipment 101 receiving the user data downlink scheduling grant or receiving the actual downlink data.

It will be appreciated that any suitable method of communicating the SG/reporting request to the first user equipment 101 may be used. Specifically, the reporting request may be communicated in a downlink communication resource which is persistently scheduled for the user equipment. A persistent scheduling downlink communication resource may be a communication resource which is allocated to the user equipment for an extended duration and for repeated communications of data. Specifically, a persistent resource allocation may comprise repeated resource allocations (such as e.g. a plurality of time slots/frames) which extend beyond a single scheduling interval.

Specifically, the SG/reporting request may be included in a persistently scheduled downlink user communication using in-band signaling. Specifically, for an LTE system, the reporting request may be transmitted by a relatively low number of bits representing the reporting request and comprised in PDSCH transmissions to the user equipment 101. It will be appreciated that any suitable method of in-band signaling may be used.

In the system of FIG. 1, the scheduling performed by the downlink scheduler 209 takes into account the CQI values reported from the user equipments 101-105 such that data may predominantly be scheduled for user equipments experiencing good propagation conditions.

Accordingly, the reporting requests are used to provide the downlink scheduler 209 with the CQI data required for performing this scheduling accurately. However, in some embodiments, the reporting requests are dependent on the scheduling history of the user equipments.

Specifically, the reporting request for the first user equipment 101 may be dependent on the scheduling history for this user equipment 101 meeting a criterion. As an example, the decision of whether to request any channel reporting and/or the duration of the time interval etc therefor may be dependent on a previous scheduling frequency requirement and/or a previous requested resource amount requirement.

In particular, if the user equipment 101 has requested resource with a frequency that is higher than a given value (or equivalently the interval is lower than a given value), the reporting request time interval may be extended to extend from one scheduling to the next. Thus, for very frequently scheduled user equipments, it may be advantageous for the channel quality reporting to be continuous for as long as the high frequency scheduling is continued.

In contrast, user equipments which tend to request only very small amounts of resource (i.e. having only low amounts of data transmitted to it), may be scheduled without any reporting requests being generated. For example, a user equipment receiving only very little data will not use much air interface resource. Therefore, it may be more resource consuming to obtain new CQI information than to schedule this data using channel quality estimates which are very conservative. Accordingly, the downlink scheduler 209 may in such scenarios use a previously received channel quality indication which may furthermore be offset by a suitable safety margin.

Alternatively, the scheduling may be performed using a default channel quality indication if the previously received channel quality indication meets a second criterion. For example, if there is no previous channel quality indication or if this is considered to be too old to be reliable, the default channel condition may be used. The default channel condition may be set to be a reasonable worst case scenario, i.e. it may be set to correspond to a low propagation channel quality.

Similarly, the base station 107 may be arranged to set a transmission parameter in response to at least one of a previously received channel quality indication and a default channel quality indication if the scheduling history meets a given criterion. E.g., for a low resource usage user equipment, the transmission parameters may be set without requesting new CQI reporting and using either a previous CQI or a default conservative CQI assumption in case the previous CQI does not exist or is considered too old.

The transmission parameter may specifically be one of a set of transmission parameters including a modulation scheme, a transmit power, an error correction level etc. The default CQI parameter may be implicitly assumed by the base station 107 by this simply selecting a predetermined robust transmission parameter set in case the scheduling history for the user equipment meets a given criterion.

Thus in such a system a user equipment with small yet frequent downlink data transmissions are provided with a higher protection from getting preempted. Specifically, in an IEEE 802.16 system, the frequency of scheduling for a user equipment can be monitored and the CQICH allocation duration can be increased if the frequency is higher than certain threshold.

Furthermore, if the data transmissions are sufficiently small and infrequent, the user equipment may be scheduled using a known CQI with a robust transmission scheme. This may result in a suboptimal downlink resource usage but as the data amount is relatively low this may be preferable to the delay and overhead that may be introduced from de-allocating an existing CQICH and reallocating a new CQICH.

It will be appreciated that although the above description focuses on scheduling for downlink data, the approach may also be used for uplink data. For example, in situations wherein uplink communications from the first user equipment 101 are very rare, the base station 107 may not be able to accurately determine uplink channel conditions from transmissions from the first user equipment 101. In this case, it may use uplink CQI data and an assumption that the uplink and downlink channel conditions are highly correlated to assess the uplink propagation channel. Thus, the base station 107 may comprise an uplink data scheduler which uses this information to schedule uplink data (the scheduling may be based on uplink resource requests received from the user equipments 101-105).

In some embodiments, the channel quality reporting request may be a request for the user equipment to transmit a signal that can be used to determine the channel quality of an uplink channel. For example, an uplink scheduler may be implemented in the base station 107 for scheduling uplink user data. The scheduling metrics for this may be evaluated and used to determine an estimated scheduling time. Shortly before this time, the base station 107 may then transmit a channel quality reporting request to the user equipment which results in this starting to transmit an uplink sounding signal that allows the base station 107 to determine the current channel quality on the uplink from the user equipment. For example, the sounding signal may be transmitted with a known transmit power thereby allowing the current propagation path loss to be determined by a signal level measurement at the base station 107.

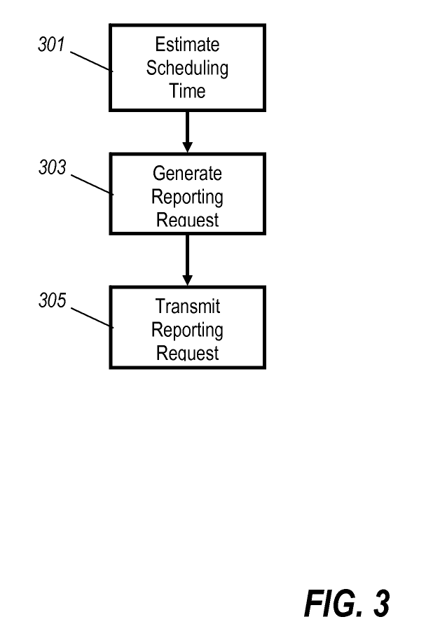

FIG. 3 illustrates an example of a method of operation for a wireless communication system comprising a scheduler for scheduling air interface resource to a plurality of user equipments.

The method initiates in step 301 wherein a scheduling time is estimated for a scheduling of an air interface resource to a first user equipment of the plurality of user equipments in response to a current scheduling priority for the first user equipment.

Step 301 is followed by step 303 wherein a channel quality reporting request is generated for the user equipment in response to the scheduling time.

Step 303 is followed by step 305 wherein the channel quality reporting request is transmitted to the user equipment.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A wireless communication system comprising:
a scheduler for scheduling air interface data for a plurality of user equipments;
an estimator for estimating a scheduling time for a scheduling of air interface data to a first user equipment of the plurality of user equipments in response to a current scheduling metric for the first user equipment;
a generating unit for generating a channel quality reporting request for the user equipment in response to the scheduling time; and
a transmitter for transmitting the channel quality reporting request to the first user equipment.

2. The wireless communication system of claim 1 wherein the channel quality reporting request comprises a reporting requirement for the first user equipment.

3. The wireless communication system of claim 2 wherein the reporting requirement comprises an indication of at least one reporting parameter from the group of:
a reporting interval requirement;
a measurement reporting requirement; and
a frequency bandwidth reporting requirement.

4. The wireless communication system of claim 1 further comprising:
a control resource scheduler for allocating a control channel resource for channel quality reporting to the first user equipment in response to the scheduling time; and wherein the generating unit is arranged to include a resource indication for the control channel resource in the channel quality reporting request.

5. The wireless communication system of claim 4 wherein the control channel resource is a time limited resource.

6. The wireless communication system of claim 1 arranged to transmit the channel quality reporting request in response to a detection that a scheduling priority of the first user equipment meets a first criterion.

7. The wireless communication system of claim 1 wherein the channel quality reporting request is indicative of a request for the user equipment to provide channel quality reporting within a time interval of the scheduling time.

8. The wireless communication system of claim 1 further comprising means for determining a reporting start time preference for channel quality reporting relative to the scheduling time, the reporting start time preference being prior to the scheduling time; and wherein the channel quality reporting request is indicative of the reporting start time preference.

9. The wireless communication system of claim 1 wherein the transmitter is arranged to transmit the channel quality reporting request in a downlink communication resource persistently scheduled for the user equipment.

10. The wireless communication system of claim 9 wherein the downlink communication resource is a user data resource of a user data communication service and the transmitter is arranged to transmit the channel quality reporting request by in-band signaling in user data of the user data communication service.

11. The wireless communication system of claim 1 wherein the channel quality reporting request is a request for reporting of at least one of a Channel Quality Indication or a Pre-encoding Matrix Information.

12. The wireless communication system of claim 1 wherein the channel quality reporting request comprises an indication of a stop condition for the first user equipment to terminate channel quality reporting.

13. The wireless communication system of claim 1 wherein the estimator is arranged to estimate the scheduling time in response to at least one parameter from the group of:
a scheduling priority for the first user equipment
a scheduling priority of other user equipments of the plurality of user equipments than the first user equipment;
a resource amount requested by other user equipments of the plurality of user equipments than the first user equipment; and
channel quality indications for other user equipments of the plurality of user equipments than the first user equipment.

14. The wireless communication system of claim 1 wherein the scheduler is arranged to schedule air interface data in response to channel quality indications for the plurality of user equipments.

15. The wireless communication system of claim 14 arranged to only transmit the channel quality reporting request if a scheduling history for the first user equipment meets a criterion.

16. The wireless communication system of claim 15 wherein the criterion comprises at least one requirement selected from the group of:
a previous scheduling frequency requirement; and
a previous requested resource amount requirement.

17. The wireless communication system of claim 15 wherein the scheduler is arranged to schedule the first user equipment in response to a previously received channel quality indication if the scheduling history does not meet the criterion.

18. The wireless communication system of claim 15 wherein the transmitter is arranged to set a transmission parameter in response to at least one of a previously received channel quality indication and a default channel quality indication if the scheduling history does not meet the criterion.

19. A base station for a wireless communication system, the base station comprising:
a scheduler for scheduling air interface data for a plurality of user equipments;
an estimator for estimating a scheduling time for a scheduling of air interface data to a first user equipment of the plurality of user equipments in response to a current scheduling metric for the first user equipment;
a generating unit for generating a channel quality reporting request for the user equipment in response to the scheduling time; and
a transmitter for transmitting the channel quality reporting request to the first user equipment.

20. A method of operation for a wireless communication system comprising a scheduler for scheduling air interface data for a plurality of user equipments, the method comprising:
estimating a scheduling time for a scheduling of air interface data to a first user equipment of the plurality of user equipments in response to a current scheduling metric for the first user equipment;
generating a channel quality reporting request for the user equipment in response to the scheduling time; and
transmitting the channel quality reporting request to the first user equipment.
